(19) United States
(12) Patent Application Publication
(10) Pub. No.: US 2026/0298678 A1
(43) Pub. Date: Oct. 1, 2026

(54) ELECTROMAGNETIC FLOWMETER WITH DIAGNOSTICS

(71) Applicant: Micro Motion, Inc., Boulder, CO (US)

(72) Inventors: Scot Ronald Foss, Eden Prairie, MN (US); Jared James Dreier, Chaska, MN (US); Kirk Allan Hunter, Eden Prairie, MN (US); Bruce David Rovner, Wailuku, HI (US)

(21) Appl. No.: 19/096,405

(22) Filed: Mar. 31, 2025

(51) Int. Cl. G01F 1/60

(52) U.S. Cl. CPC G01F 1/60

(57) ABSTRACT

An electromagnetic flowmeter for measuring a flow rate of a fluid in a pipe, the flowmeter includes a pipe for carrying a fluid and a magnetic coil disposed adjacent to the pipe for inducing a magnetic flux in the fluid. A plurality of electrodes are at least partially disposed within the pipe and are electrically isolated from one another. Measurement circuitry coupled to two of the plurality of electrodes and the magnetic coil is configured to apply a drive signal to the magnetic coil, responsively sense a measurement signal as a function of a potential across two of the plurality of electrodes. The measurement circuitry senses flow rate as a function of the sensed measurement signal. Diagnostic circuitry coupled to at least two of the plurality of electrodes is adapted to apply a diagnostic signal having a time varying component to at least one electrode used to sense flow rate and to determine a diagnostic condition of the at least one electrode based on an impedance measured using a sensed response to the applied diagnostic signal.

### BACKGROUND

The present invention relates to magnetic flowmeters used for measuring a fluid flow within a conduit. More particularly, the invention relates to detection of a diagnostic condition of an electrode in a magnetic flowmeter of the flowmeter itself.

Generally, magnetic flowmeters measure a fluid flow rate by measuring an electric potential across two electrodes within the pipe segment, where the electric potential is induced within the flow by the presence of an electromagnetic field. The operating principle of the magnetic flowmeter is based on Faraday's Law of electromagnetic induction, which states that a voltage will be induced in a conductor moving through a magnetic field. The magnitude of the induced voltage is directly proportional to the velocity of the fluid flow, the width of the conductor, and the strength of the magnetic field.

Magnetic flowmeters may include circuitry and/or software for detecting empty pipe conditions. Unfortunately, under certain circumstances, empty pipe detection circuitry may still provide false indications of empty pipe conditions. Further, material can collect on the electrodes, or the electrodes may corrode or erode, which can lead to inaccurate flow measurements.

Therefore, there is an on-going need in the process industry for a magnetic flowmeter with improved diagnostic capabilities. Embodiments of the present invention provide solutions to these and other problems, and offer other advantages over the prior art.

### SUMMARY

An electromagnetic flowmeter for measuring a flow rate of a fluid in a pipe, the flowmeter includes a pipe for carrying a fluid and a magnetic coil disposed adjacent to the pipe for inducing a magnetic flux in the fluid. A plurality of electrodes are at least partially disposed within the pipe and are electrically isolated from one another. Measurement circuitry coupled to two of the plurality of electrodes and the magnetic coil is configured to apply a drive signal to the magnetic coil, responsively sense a measurement signal as a function of a potential across two of the plurality of electrodes. The measurement circuitry senses flow rate as a function of the sensed measurement signal. Diagnostic circuitry coupled to at least two of the plurality of electrodes is adapted to apply a diagnostic signal having a time varying component to at least one electrode used to sense flow rate and to determine a diagnostic condition of the at least one electrode based on an impedance measured using a sensed response to the applied diagnostic signal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a simplified diagram of a magnetic flowmeter system having a tunable empty pipe function according to an embodiment of the present invention.

FIG. 2 illustrates a magnetic flowmeter flow pipe assembly according to an embodiment of the present invention.

FIG. 3 is a simplified block diagram of illustrating functional elements of the transmitter and magnetic flowmeter according to an embodiment of the present invention.

FIG. 4 is a simplified diagram showing electrical impedance between electrodes in a flow meter.

FIG. 5 is a graph of signal amplitude versus time showing an applied diagnostic signal and a sensed measurement signal.

FIG. 6 is a simplified electrical schematic diagram of diagnostic circuitry in accordance with one example embodiment.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

The present invention includes a magnetic flowmeter having diagnostic circuitry. In one aspect, the diagnostic circuitry determines a diagnostic condition of at least one of the electrodes used to measure flow rate based upon an impedance measured using an applied diagnostic signal. In specific aspects, the diagnostic circuitry identifies a diagnostic condition related to contact between the electrode and process fluid carried in a pipe of the flowmeter. This condition may be related to an empty pipe where the process fluid does not contact the electrode. In another aspect, the diagnostic circuitry identifies a diagnostic condition related to electrode degradation due to, for example, a coating of material on the electrode has if the electrode has suffered from corrosion or erosion.

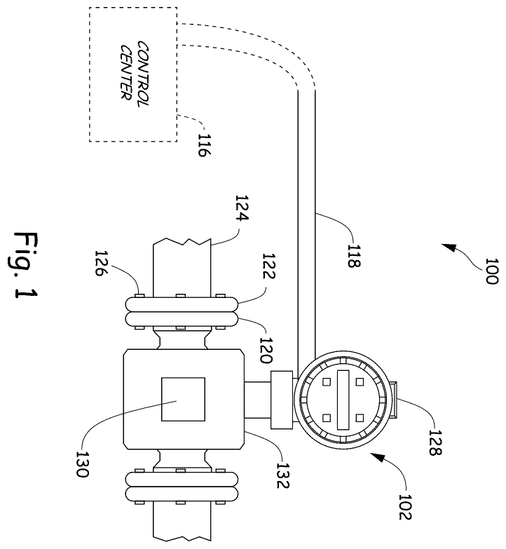

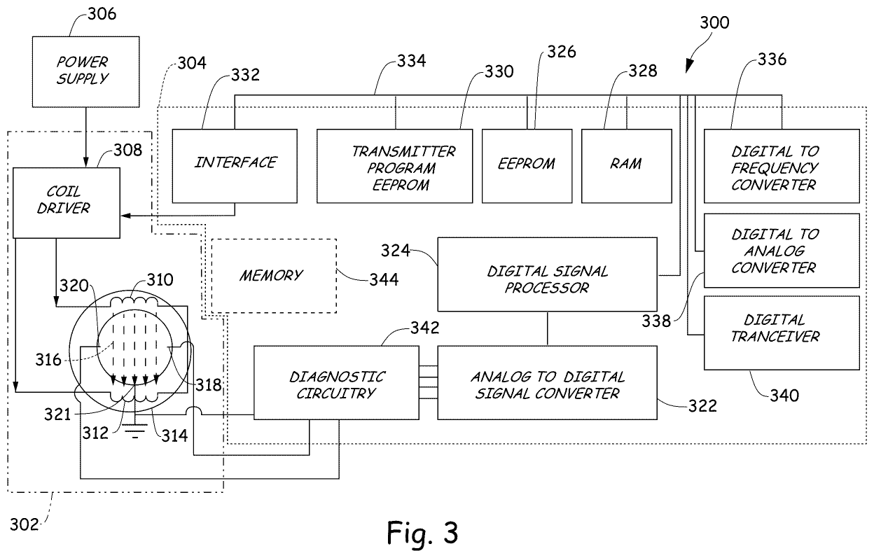

FIG. 1 illustrates a simplified diagram of a magnetic flowmeter assembly 100 having diagnostic circuitry according to an embodiment of the present invention. Magnetic flowmeter assembly 100 includes a magnetic flowmeter 102. A process control loop 118 couples flowmeter 102 to a control room 116. This loop 118 can be a wired or wireless process control loop. The connection can be used for transmitting alarm signals, measurement data, and the like and for receiving control signals. Process electronics are generally housed within the flowmeter and can be electrically coupled to the local user interface 106. Parameters can also be provided to, or read from, flowmeter 102 over loop 118 as well as through a handheld communicator or the like. In addition to circuitry for determining a diagnostic condition of an electrode (illustrated generally in FIG. 3), the process electronics may include a memory for storing raw flow measurement data, a microprocessor, and software (sometimes referred to as “firmware”).

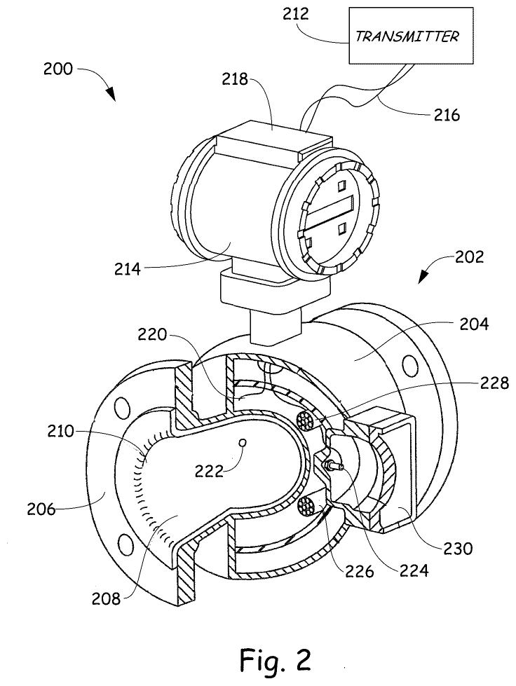

Electrical interconnects and magnetic coils (shown in FIGS. 2 and 3) are confined within the flowmeter 102 and are isolated from the environment and from the process.

Generally, the magnetic flowmeter 102 is coupled to pipe section 124 by flanges 120 and corresponding pipe flanges 122 using threaded fasteners 126. Though FIG. 1 illustrates a pipe section 124, which is a tube, the flowmeter 102 can be coupled to other types of fluid conveying structures as well. As used herein, the term “pipe” refers generally to any conduit for conveying fluid, including a tube, a channel, and the like.

Finally, access panel 128 may be provided to allow an operator access to the electrical interconnections for coupling the transmitter 104 to the flowmeter 102 via conduit 118. Additionally, access panel 130 may be provided to permit operator access to electrode wiring within the flowmeter body 132.

FIG. 2 illustrates a magnetic flowmeter assembly 200 in another example configuration including a magnetic flowmeter 202 with a portion shown in cross-section. The magnetic flowmeter 202 includes a pipe section 204 with flanges 206 for coupling to a pipe or conduit of an industrial process. The pipe section 204 defines a passage 208 for fluid flow. Generally, the pipe section 204 is formed of a rigid material, such as nonmagnetic stainless steel for pressure containment, and may be lined with an electrically insulating liner 210, such as Teflon, polyurethane, Tefzel, other plastic resin, ceramic, or other types of electrically insulating materials. For lower pressure applications, pipe section 204 can be formed from electrically insulative material, in which case liner 210 may be omitted. Other designs of passages 208 can be used as well. For example, a metal pipe section can be used having only a partial insulating lining such as an insulating annulus about each electrode.

Additionally, though the flowmeter 202 is shown with flange elements 206, other connection means are possible. In an alternative embodiment, the pipe section 204 can be formed without flanges, and the flowmeter 202 can be clamped between flanges of mating pipes using extended bolts to cage the flowmeter 202.

In general, a transmitter 212 is coupled to electronics housing 214 of the flowmeter 202 via wiring 216. The electronics housing 214 is provided with a releasable cover 218 to allow operator access to an electrical distribution block and electrical connectors provided within the electronics housing 214. Alternatively, the transmitter can be contained within the housing 214.

Electrical leads 220 extend from within the electronics housing 214 into the pipe section 204 to connect to electrodes 222 and 224 and to magnetic coils 226 and 228. Finally, access panel 230 is provided to allow operator access to wiring within the pipe section 204.

The magnetic coils 226 and 228 are excited to generate a magnetic field, which induces a voltage in the process fluid flow within the pipe section 204. The electronics within the electronics housing 214 measures the voltage potential between the two electrodes 222 and 224, which can be used to determine a rate of flow. Specifically, the magnitude of the induced voltage (E) is directly proportional to the velocity of the conducting fluid (V), the conductor width (W), and the strength of the magnetic field (B) according to the following equation: E=kBWV Where the variable k represents a constant. The magnetic field coils 226 and 228 are generally positioned on opposing sides of the pipe section 204 to generate the field. As the conductive liquid moves through the field with average velocity (V), the electronics measures the voltage potential across electrodes 222 and 224. Alternatively, the electronics can be configured to measure a voltage potential relative to ground or relative to a process reference. In one embodiment, the process reference is a fixed potential.

Since the width (W) is the spacing between the electrodes and the magnetic field (B) is controlled by the magnetic coils 226 and 228, the only variable is the velocity (V) of the process fluid. The liner 210 (or an insulating element) prevents the voltage signal from shorting to the pipe wall. Thus, the output voltage (E) is directly proportional to the liquid velocity, resulting in an inherently linear output. This output voltage (E) may also be referred to as an “electromotive force” (EMF), a “flow signal”, a “potential” or an “electrode voltage”. It should be understood that electrodes 222 and 224 contact the fluid in the passage 208 (when liquid is present), and the fluid completes a circuit between the electrodes 222 and 224.

Generally, the process circuitry in transmitter 212 (or in a remote location) provides a liquid conduction indication. An empty pipe condition can be triggered by monitoring the conductivity between electrodes 222,224, for example. However, an incorrect empty pipe determination can occur when, for example, fluid within the pipe is very conductive and moisture sticks to the walls of the pipe providing a lower than expected resistance between the electrodes 122,124 when the pipe is empty. In such an instance, the pipe section 204 may be substantially empty, but the magnetic flowmeter 202 can still give a false indication that there is fluid flow through the pipe section 204.

FIG. 3 is a simplified block diagram of a magnetic flowmeter assembly 300 illustrating some of the functional elements of a transmitter according to an embodiment of the present invention. The assembly 300 includes a magnetic flowmeter 302, which is coupled to transmitter 304 via an electrical connection.

The magnetic flowmeter 302 receives power from a power supply 306 (such as the loop wiring or other power supply). The power received by the flowmeter 302 drives the coil driver 308, which powers the magnetic coils 310 and 312 disposed on opposing sides of the flow pipe 314 to generate a magnetic field 316 through the flow pipe 314. The drive signal is typically a square wave such that the direction of electrical current through the coils 310,312 periodically reverses direction. Electrodes 318 and 320 sense the induced voltage due to the applied magnetic field and flow of process fluid, which is processed by an analog to digital signal converter 322. This conversion allows for precise corrections and engineering unit conversion. Digital signal processor (DSP) 324 receives the converted digital signal from converter 322. The DSP 324 can perform various processing steps on the data and on the flowmeter 302, including diagnostics, signal processing, electronics and tube calibrations, and the like. A ground electrode 321 is also provided for coupling to process ground. Diagnostic circuitry 342 is also coupled to electrodes 318,320 to determine a diagnostic condition of the electrodes 318,320 as discussed herein. Diagnostic circuitry 342 can also optionally couple to ground electrode 321.

Configuration data for the assembly 300 is preferably stored in nonvolatile electronically erasable programmable read only memory (EEPROM) 326. The EEPROM 326, RAM 328, transmitter program EPROM 330 (which stores the transmitter firmware), and interface 332 are connected to the microprocessor 324 via bus 334. Depending on the specific implementation, the transmitter 304 may be adapted to produce various outputs, including a zero to 10,000 Hertz output signal from the digital to frequency converter 336, a 4 to 20 mA output signal from a digital to analog converter 338, or a hybrid of digital and analog signals using the digital transceiver 340, which can be coupled to the output of the digital to analog converter 338. Thus, the assembly 300 can be utilized with a standard FieldBus implementation. Elements 336, 338 and 340 provide I/O circuitry to the flowmeter assembly 300.

The sense electrodes 318,320 can respond to different noise sources such as line noise, coil voltage, etc., when the pipe is empty of process fluid. The electrodes 318,320 are essentially antennas when no process fluid is present. This noise can create false flow signals that can reach the full flow range of the magnetic flowmeter, for example, a flow rate of more than 40 ft/sec. The false flow measurement will get added to the flow totals and can lead to large errors in these totals. This can lead to over/under billing in custody transfer applications or other errors.

Traditionally, in order to sense an empty pipe condition, magnetic flowmeters have measured the impedance from the sense electrodes to the process ground or have provided additional electrodes dedicated to empty pipe detection. However, additional electrodes add cost and are another potential leak point. They also depend on having a good process ground connection to avoid false empty pipe detection. In many installations, a good process ground connection is not available.

Further, the sense electrodes 318,320 in a magnetic flowmeter can become coated with a non-conductive coating. For example, Paraffin deposits are common in the oil fields. In one specific configuration, two magnetic flowmeters are used to measure flow through a conduit at two locations. These are used to detect leaks in the conduit by ensuring both flowmeters measure the same amount of flow of process fluid. However, if one of the flow meters develops a coating on its electrodes, this will cause a mismatch in the two flow measurements which will falsely indicate that there is a leak. Similarly, erosion or corrosion of the electrodes 318,320 can also cause errors in flow measurements. Measuring and informing an operator that the flowmeter electrodes have degraded to a certain level due to coating or corrosion allows the operator to schedule cleaning or other maintenance at a desired time.

Prior techniques to detect electrode degradation have typically measured the impedance from the sense electrodes to the process ground, or have used one or more additional electrodes dedicated to detecting electrode coating. This is problematic as discussed above.

With the present invention, a magnetic flowmeter is provided which can measure the AC impedance between three different process fluid connections. These connections are between the two sense electrodes 318,320 and ground electrode 321. Diagnostic circuitry operates with the functionality to measure complex impedance (inductance, capacitance and resistance) between any two electrodes of the device. Further, the measurements can be obtained at more than one frequency for additional diagnostic information. The measurements are obtained in a manner that does not interfere with the flow measurement or the flow gain verification that is performed while the magnetic flowmeter is in operation. Although any number of electrodes can be used, in this specific implementation of three electrodes, measurements can be obtained for the following three pairs of electrodes:
Positive electrode 318 to negative electrode 320.
Positive electrode 318 to process ground 321.
Negative electrode 320 to process ground 321.

Note that the process electrical ground can be implemented with a metal pipe, ground rings, liner protectors, a dedicated electrode, or other means.

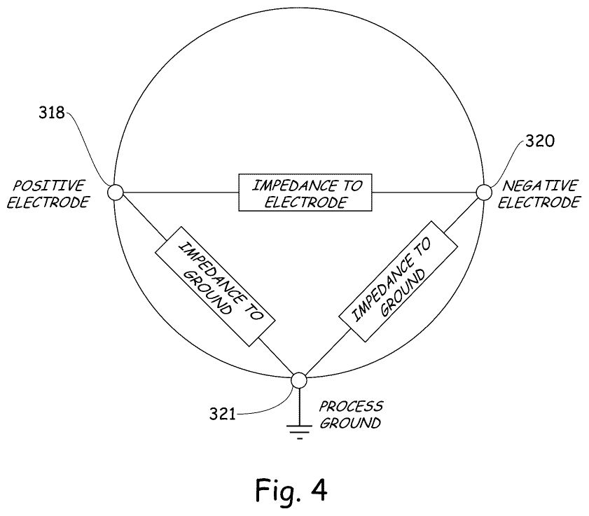

The main measurement desired for empty pipe detection is typically between the positive 318 and negative 329 sense electrodes, as shown in FIG. 4. As these are the electrodes that are used to generate the measurement flow signal, they are the most crucial to flow meter operation. In one configuration, the new empty pipe detector measures the impedance between the positive and negative sense electrodes 318,320 which are used to measure the EMF due to the applied magnetic field and flow of the process fluid.

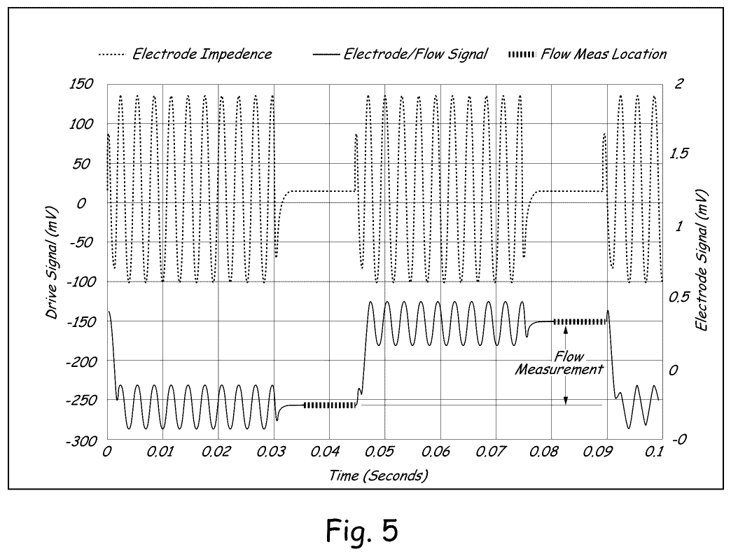

Referring to FIG. 5, in order to measure the impedance between two electrodes, a sine wave (diagnostic signal) is injected through resistors across the electrodes and measurement circuitry to create a voltage divider. The voltage out is measured, and AC circuit analysis is used to solve for a parallel RC model of the electrode complex impedance. The coil drive signal is typically a square wave that causes current through the coils 310,312 to periodically reverse direction and generates the applied magnetic field. This causes a measurement signal to be sensed by electrodes 318,320 which is also a square wave at the same frequency having an amplitude which is related to flow rate. The sensed square wave measurement signal can be seen in the lower signal shown in FIG. 5. In one aspect, the diagnostic signal is injected during a specific time in the period of the magnetic coil drive signal. For example, the sine wave diagnostic signal can be injected during a period in which flow is not being measured. Specifically, during the period that the measurement circuitry waits for the flow measurement signal to settle and stabilize following a reversal of the applied magnetic field. In this example, the flow is measured during the trailing 20% of the square wave to allow the magnetic field to settle.

The diagnostic signal can be applied at different frequencies to collect additional diagnostic information. The different frequency signals can be applied simultaneously or sequentially, or a combination of both.

Additionally, in one configuration, the applied impedance diagnostic signal has a frequency which is an even harmonic of the coil drive frequencies. This guarantees that the flow measurement signal will not be affected by the impedance drive signal. The impedance measurement diagnostic signal frequency is automatically adjusted to account for line noise harmonics and the harmonics of the flow signal.

The impedance measurement diagnostic signal amplitude is continually adjusted to ensure that the signal is large enough to obtain an accurate measurement, but not too large to saturate the analog to digital convertor 322 and the measured impedance changes.

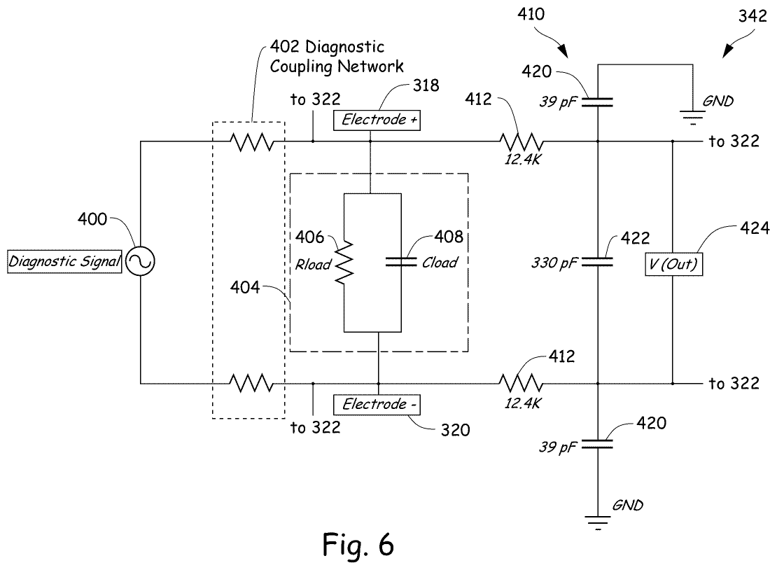

FIG. 6 is a simplified schematic diagram of diagnostic circuitry 342 according to one embodiment. The diagnostic circuitry 342 includes a diagnostic signal source 400 which injects the diagnostic signal into the electrodes 318,320 through diagnostic coupling network 403. In one specific example, network 402 is formed by series connected resistors. The diagnostic signal source 400 can be a voltage or current source. The impedance 404 between electrodes 318 and 320 is illustrated by a load resistor R_{load} 406 and a load capacitor C_{load} 408. The diagnostic signal from V_{source} 400 is applied to the electrodes 318, 320 through resistors 402. Electrodes 318 and 320 are also connected to a capacitor network 410 through resistors 412 which are 12.4 K Ohm resistors. A capacitor bank 410 is formed by capacitors 420 which connect the resistors 412 to electrical ground. Capacitor 422 which is electrically connected between resistor 412. In one configuration, capacitors 420 are 39 pF and capacitor 422 has a capacitance of 330 pF. This configuration generates an output Vₒᵤₜ 424 which is the measurement signal generated by the flow of the process fluid in the applied magnetic fields and filters out the diagnostic signal. Further, the measurement output signal 424 is also coupled to analog to digital convertor 322 for measurement of flow rate.

The electrodes 318 and 320 are connected to analog to digital convertor 322 through diagnostic circuitry 342 for measuring a response of the applied diagnostic signal. The magnitude and phase of the response of the electrodes 318,320 to the applied diagnostic signal can be measured using spectrum analysis or other means. The simplified circuit model illustrated at 404 can be solved to determine the impedance (R_{load} and C_{load}) across the electrodes 318,320. The resistance 406 in this model is not affected by cabling capacitance and other parasitic components. More complex models can also be implemented and used to separately identify the process fluid impedance and other components such as a coating on electrodes 318,320. This configuration allows a differential impedance level to be measured between the electrodes that are used to measure flow.

The resistance between the positive 318 and negative 320 electrodes is modeled as resistor 406 and can be used for the empty pipe detection. For example, a maximum acceptable resistance level can be set for a particular process fluid and flowmeter installation. If the resistance of resistor 406 exceeds this empty pipe limit, then the pipe is determined to be empty of process fluid. Upon detection of an empty pipe condition, measurement circuitry, such as processor 324 can set the measured flow out put to zero. This can also be used to generate an alarm. Note, in the configuration of FIG. 6, the electrodes can be any of the positive, negative or ground electrodes. Additionally, the impedance modelled at 404 can include large capacitors connected in series with electrodes 318,320 to represent the interface between an electrode and the process fluid.

There are a wide variety of installation and process conditions that can affect the electrode-to-electrode resistance represented by resistor 406. Some of these can create a false empty pipe detection, while others can delay or prevent the empty pipe condition from being detected. These conditions include:
A process fluid having a conductivity which varies over a wide range, for example, a process fluid conductivity ranging from 2 μS to 2000 μS.
The deposition of a non-conductive coating on the electrodes.
A layer of material deposited on the flow tube that provides an electrically conductive path between the electrodes.
A conductive film between the electrodes caused by different chemicals in the process.
Erosion or corrosion of the electrodes, resulting in poor electrical coupling between the electrodes and the process fluid.

In order to address the variability in electrode resistance measurements, the empty pipe resistance trigger limit can be adjusted as desired. For example, the measured electrode resistance can be provided as a value to the operator using local interface 332 or through some other means. The operator can then use this measured resistance to set the trigger level to an appropriate value. This along, with hysteresis and an adjustable detection time, will give the operator the tools they need to reliably detect an empty pipe condition. The resistance value, hysteresis information, and detection time information can be stored in, for example, memory 328 and compared to real time measurements during operation by processor 324 to generate an alarm. Further, the individual electrode to process ground measurements can be used to enhance the empty pipe measurement with comparing multiple measurements take at different time intervals.

As discussed above, the impedance between the positive and negative electrodes 318,320 can also be for the electrode coating or electrode degradation detection. Similar to empty pipe detection, a user defined limit can be stored in memory 326 and used to detect when the electrode resistance goes above a certain limit. Two separate limits can be set, one used to give the user a warning of impending failure and one used to send an alarm indicating the electrodes have degraded outside of predetermined acceptable limits. The first level can provide an indicating that maintenance should be scheduled, and the electrodes cleaned or replaced, such as during the next scheduled plant shutdown. The second level can be used to indicate that the flow measurement is being affected by the electrode coating. The processor 324 can communicate when these limits have been met using, for example, a status bit, digital output, or analog output alarm through I/O 336, 338 or 340.

The diagnostic circuitry 342 can also be used to measure the electrical resistance between an electrode 318 or 320 and ground electrode 321. The resistance between individual electrodes 318 or 320 to process ground 321 can be measured and used to enhance the electrode coating detection by obtaining multiple measurements. If the measurements agree, it is a further indication that the electrodes have degraded.

Note that both electrode degradation and an empty pipe condition can cause an increase in the measured resistance. If there is a significant difference in the resistance when either of these conditions occur, the measured resistance can be used to identify if the system is experiencing an empty pipe event or if the electrodes have become degraded. Another technique that can be used to differentiate between the two events is to observe the rate at which the resistance changes. A slow change over a long time period can indicate electrode degradation. On the other hand, a more abrupt change in the resistance can indicate an empty pipe condition.

The invention provides a new and unique way to obtain electrode diagnostic information that is both faster and more reliable than previous methods. The diagnostics are based upon measuring the complex impedance between the flow sensing electrodes or the ground electrode. The flowmeter performs a complex circuit analysis to measure the electrode resistance between the flow sensing electrodes, which can be done at multiple frequencies. Multiple frequencies measurements can be used to provide a better average resistance measurement. Further, the multiple frequencies can be applied at the same time to provide faster updates. Further, the diagnostics can be performed during normal operation of the magnetic flowmeter and does not require flow measurement to be paused. The limits that are used for detection of a diagnostic condition can be adjusted by a user to address challenging process configurations.

Although the present invention has been described with reference to preferred embodiments, workers skilled in the art will recognize that changes may be made in form and detail without departing from the spirit and scope of the invention. Measurement circuitry can include coil driver 308, A/D signal converter 322 along with processor 324. Processor 324 can comprise a digital signal process, microprocessor, microcontroller, or the like. Diagnostic circuitry can be implemented using circuitry 342, A/D converter 322 and processor 324. Although comparison of the resistance of resistor 406 to a resistance level limit is discussed, comparison of the capacitance of capacitor 408 to a capacitance limit can also be used for diagnostic purposes. Complex impedance measurements can also be used for diagnostics. The diagnostic signal can be any type of signal that can be used to measure a complex impedance. Typically, this is a time varying signal. Although a sine wave is specifically discussed herein, other waveforms having a time varying component can also be used. Further, as discussed, more than one diagnostic signal can be applied. For example, diagnostic signals at differing frequencies and/or phases can be used.

What is claimed is:

1. An electromagnetic flowmeter for measuring a flow rate of a process fluid, the flowmeter comprising:
a pipe for carrying the process fluid;
a magnetic coil disposed adjacent to the pipe for inducing a magnetic flux in the process fluid;
a plurality of electrodes at least partially disposed within the pipe, the electrodes electrically isolated from one another;
measurement circuitry coupled to at least one of the plurality of electrodes and the magnetic coil configured to apply a drive signal to the magnetic coil having a time varying component at a first frequency, responsively sense a measurement signal as a function of a potential across the plurality of electrodes due to the applied magnetic field and the flow of process fluid, and determine flow rate of the process fluid based upon the sensed measurement signal; and
diagnostic circuitry coupled to at least two of the plurality of electrodes adapted to apply a diagnostic signal having a time varying component to the at least one electrode used to determine flow rate of the process fluid and determine a diagnostic condition of the at least one electrode based on an impedance measured using a sensed response to the applied diagnostic signal.

2. The electromagnetic flowmeter of claim 1 wherein the diagnostic condition is determined based upon a real component of the measured impedance.

3. The electromagnetic flowmeter of claim 1 wherein the diagnostic signal has a time varying component at a second frequency.

4. The electromagnetic flowmeter of claim 1 wherein the diagnostic signal has a time varying component at multiple frequencies.

5. The electromagnetic flowmeter of claim 4 wherein the multiple frequencies are applied at different times.

6. The electromagnetic flowmeter of claim 4 wherein the multiple frequencies are applied at the same time.

7. The electromagnetic flowmeter of claim 3 wherein the second frequency is a harmonic of the first frequency.

8. The electromagnetic flowmeter of claim 1 wherein the diagnostic condition is based upon a comparison of the response to the applied diagnostic signal and a diagnostic limit.

9. The electromagnetic flowmeter of claim 8 wherein the diagnostic limit is adjustable.

10. The electromagnetic flowmeter of claim 8 wherein the diagnostic limit comprises a resistance level.

11. The electromagnetic flowmeter of claim 8 wherein the diagnostic limit comprises a capacitance level.

12. The electromagnetic flowmeter of claim 1 wherein the diagnostic signal comprises a sine wave.

13. The electromagnetic flowmeter of claim 1 wherein the flow rate is determined from the measurement signal after the applied magnetic field has settled.

14. The electromagnetic flowmeter of claim 13 wherein the diagnostic signal is applied to the at least one electrode prior to the applied magnetic field having settled.

15. The electromagnetic flowmeter of claim 1 wherein the diagnostic circuitry includes an analog to digital convertor to digitize the response to the applied diagnostic signal.

16. The electromagnetic flowmeter of claim 1 wherein the diagnostic condition comprises an empty pipe condition.

17. The electromagnetic flowmeter of claim 1 wherein the diagnostic condition indicates degradation of at least one of the plurality of electrodes.

18. The electromagnetic flowmeter of claim 1 wherein the degradation comprises buildup of a coating on at least one of the electrodes.

19. The electromagnetic flowmeter of claim 1 wherein one of the plurality of electrodes comprises a ground electrode.

20. The electromagnetic flowmeter of claim 11 wherein the diagnostic limit includes hysteresis.

21. The electromagnetic flowmeter of claim 1 wherein the diagnostic condition is determined based upon a rate of change of the response to the applied diagnostic signal.

22. The electromagnetic flowmeter of claim 1 wherein the diagnostic circuitry measures a differential impedance between a same two electrodes which are used by the measurement circuitry to determine flow rate of the process fluid.
